(19) United States
(12) Patent Application Publication
(10) Pub. No.: US 2025/0381746 A1
(43) Pub. Date: Dec. 18, 2025

(54) AUTOMATED LABORATORY APPARATUS FOR DYNAMICALLY TESTING THE DURABILITY OF SELF-SEALING TIRE SEALANTS

(71) Applicants: DOW GLOBAL TECHNOLOGIES LLC, Midland, MI (US); DOW SILICONES CORPORATION, Midland, MI (US)

(72) Inventors: Liangkai MA, Midland, MI (US); Joel CERVA, Midland, MI (US); Mark H. MIRGON, Midland, MI (US); Timothy MORLEY, Midland, MI (US); Thomas PARSONS, Midland, MI (US); Kevin L. CHURCH, Midland, MI (US); Frederic GUBBELS, Seneffe (BE); Kyle ATKINS, Midland, MI (US)

(21) Appl. No.: 19/112,088

(22) PCT Filed: Sep. 13, 2023
(86) PCT No.: PCT/US2023/032587

§ 371 Date: Mar. 14, 2025

Related U.S. Application Data
(60) Provisional application No. 63/407,327, filed on Sep. 16, 2022.

(51) Int. Cl. B29D 30/00; B29D 30/06; G01N 19/00; G01N 25/00

(52) U.S. Cl. CPC B29D 30/0061; G01N 19/00; G01N 25/00; B29D 2030/0066; B29D 30/0685

(57) ABSTRACT

An automated laboratory apparatus for dynamically testing the durability of a coating is provided. The apparatus includes an actuator that drives at least one test unit. Each test unit includes a pressure chamber assembly having a main body and a clamping member. The main body includes a monitoring window, an opening, and an inner chamber wall defining a pressure chamber within the main body. The clamping member includes a central opening. The clamping member and main body are adapted to sandwich a substrate including the coating therebetween to close the pressure chamber. A driven member extends through the central opening in the clamping member and is contactable with the substrate. The actuator drives one or both of an oscillating linear and an oscillating rocking motion of the driven member. A method of testing the durability of a tire coated with a self-sealing sealant for leak-proof performance is also provided.

### CROSS REFERENCE TO RELATED APPLICATIONS

The application claims priority to and all advantages of U.S. Provisional Patent Application No. 63/407,327 filed on 16 Sep. 2022, the content of which is incorporated herein by reference.

### FIELD OF THE INVENTION

The present disclosure relates generally to testing the durability of coating materials on a substrate and, more specifically, to an apparatus and method for testing the durability of self-sealing tire sealant materials.

### DESCRIPTION OF THE RELATED ART

A “self-sealing tire” (SST) is a tire having its inside surface coated with a layer of self-sealing sealant material that is typically composed of a sticky polymer, synthetic rubber, or natural rubber material. The self-sealant material fills and seals a puncture up to a certain size in the tire tread of the tire so that the tire does not experience a loss of air pressure. Thus, a vehicle on which the tire and associated wheel are mounted may be safely driven without any noticeable loss of control or handling until the tire is permanently repaired.

Conventionally, testing of the reliability and durability of self-sealing tire materials included in self-sealing tires is highly challenging and time consuming. Current testing methods require the tires to be mounted on a vehicle and the vehicle driven on a road, test track or other proving ground for a significant period of time at different driving speeds and road conditions in order to obtain adequate test data related to the performance of the tires when punctured and subjected to road and environmental stresses. Hence, current testing methods are costly and require a significant amount of time to complete. Therefore, a need exists for a way to test self-sealing tire sealants that can be accomplished at one or more of a shorter time frame, a lower cost, and a lower level of carbon dioxide emissions.

### BRIEF SUMMARY OF THE INVENTION

An automated laboratory apparatus for dynamically testing the durability of a coating is provided. The apparatus includes an actuator and a driveshaft coupled to the actuator. The apparatus further includes a test unit including a cam assembly, a support flanking the cam assembly, and a pressure chamber assembly. The cam assembly is mounted on the driveshaft and includes a cam lobe, a follower, and a driven member. The cam lobe is eccentrically mounted on the driveshaft. The follower is in urged engagement with the cam lobe and includes a circular body surrounding the cam lobe. The driving arm protrudes from the circular body. The pressure chamber assembly is mounted on a support and aligned with the cam assembly. The pressure chamber assembly includes a main body and a clamping member. The main body includes a monitoring window, an open end including an opening, and an inner chamber wall adjacent the opening and defining a pressure chamber within the main body. The clamping member includes a central opening. The clamping member and main body are adapted to sandwich a substrate including the coating therebetween to close the pressure chamber with the coating facing inside the pressure chamber. The driven member extends through the central opening in the clamping member and is contactable with the substrate. Rotation of the driveshaft drives one or both of an oscillating linear and an oscillating rocking motion of the driven member via the cam assembly.

In specific embodiments, the driven member is one of a puncturing object and a blunt object.

In particular embodiments, the puncturing object is one of a nail, a screw, and a member having a point.

In specific embodiments, the main body of the pressure chamber assembly includes a seal circumscribing the opening. The seal includes a pair of concentric annular ridges forming an annular groove therebetween.

In specific embodiments, the apparatus further includes an insert disposed between the support and the clamping member, for adjusting a height of the pressure chamber assembly relative to the cam assembly.

In specific embodiments, the apparatus further includes a pressure sensor for monitoring pressure in the pressure chamber.

In specific embodiments, the apparatus further includes a source of compressed air in fluid communication with the pressure chamber via a supply line, and at least one valve connected to the supply line for charging and discharging the pressure chamber.

In specific embodiments, the apparatus further includes a controller electrically connected to one or more of the actuator, the pressure sensor, and the at least one valve.

In specific embodiments, the apparatus further includes a user interface electrically connected to the controller for setting test parameters and monitoring pressure in the pressure chamber.

In specific embodiments, the apparatus includes a plurality of the test units.

A method of testing the durability of a tire coated with a self-sealing sealant for leak-proof performance is also provided. The method includes the steps of providing the automated laboratory apparatus and providing the substrate. The substrate is a tire sample cut from a tire. The tire sample includes a tire tread on one surface, and an opposite inner surface having a layer of self-sealing sealant thereon. The method further includes sandwiching the tire sample between the pressure chamber main body and the clamping member with the tire tread of the tire sample facing the clamping member and the layer of sealant on the inner surface of the tire sample facing the pressure chamber. The method further includes inserting the driven member into the tire sample through the central opening in the clamping member, wherein the driven member is a puncturing object. The method further includes mounting the pressure chamber assembly onto the support and the inserted driven member onto the cam assembly. The method further includes charging the pressure chamber with compressed air to a predetermined set pressure. The method further includes actuating the actuator to drive the puncturing object and cause the puncturing object to move within the tire sample in one or both of an oscillating linear and an oscillating rocking motion. The method further includes monitoring the pressure in the pressure chamber while the puncturing object is driven. The method further includes dismounting the puncturing object from the cam assembly and dismounting the pressure chamber assembly to check for leaks at a puncture site in the tire sample. The method further includes removing the puncturing object from the tire sample and mounting another driven member onto the cam assembly, wherein the driven member is a blunt object. The method further includes mounting the pressure chamber assembly onto the support, whereby the blunt object contacts the tire tread of the tire sample. The method further includes actuating the actuator to drive the blunt object and cause the blunt object to move so that it periodically punches the tire tread of the tire sample proximate to the puncture site. The method further includes monitoring the pressure in the pressure chamber while the blunt object is driven. The method further includes subsequently subjecting the automated laboratory apparatus including the tire sample to a thermal cycle while further monitoring the pressure in the pressure chamber and checking for leaks at the puncture site.

In specific embodiments, the method further includes monitoring the inner surface of the tire sample in the pressure chamber via the monitoring window.

In specific embodiments, the method further includes using a camera to monitor and/or record activity in the pressure chamber at the puncture site.

In specific embodiments, the method further includes providing an environmental chamber within which the automated laboratory apparatus is placed. One or both of the temperature and humidity in the environmental chamber may be adjusted while the automated laboratory apparatus is in the environmental chamber.

In specific embodiments, the method further includes preforming the steps of actuating the actuator and monitoring the pressure at one or both of a plurality of ambient temperatures and a plurality of humidity levels.

### DESCRIPTION OF THE DRAWINGS

Various advantages and aspects of this disclosure may be understood in view of the following detailed description when considered in connection with the accompanying drawings, wherein:

FIG. 1 shows a side, sectional view of a laboratory testing apparatus in accordance with some embodiments of the disclosure;

FIG. 2 shows a perspective, partially exploded view of the laboratory testing apparatus of FIG. 1;

FIG. 3 shows a perspective view of a laboratory testing apparatus in accordance with other embodiments of the disclosure;

FIG. 4 shows a side view of the laboratory testing apparatus of FIG. 3;

FIG. 5 shows a sectional view of the laboratory testing apparatus of FIG. 3 taken along the line 5-5 in FIG. 4;

FIG. 6 shows a top view of the laboratory testing apparatus of FIG. 3;

FIG. 7 shows a sectional view of the laboratory testing apparatus of FIG. 3 taken along the line 7-7 in FIG. 6;

FIG. 8 shows a sectional view of a cam assembly of the laboratory testing apparatus in accordance with some embodiments of the disclosure;

FIG. 9 shows a sectional view of a cam assembly of the laboratory testing apparatus in accordance with other embodiments of the disclosure;

FIG. 10 shows a perspective view of a cam assembly of the laboratory testing apparatus in accordance with yet other embodiments of the disclosure;

FIG. 11 shows a side view of the cam assembly of FIG. 10;

FIG. 12 shows a section view of the cam assembly of FIG. 10 taken along the line 12-12 in FIG. 11;

FIG. 13 shows a driven member of the laboratory testing apparatus in accordance with certain embodiments of the disclosure;

FIG. 14 shows a perspective, sectional view of a main body of a pressure chamber assembly of the laboratory testing apparatus in accordance with some embodiments of the disclosure;

FIG. 15 shows an exploded view of a pressure chamber assembly of the laboratory testing apparatus in accordance with some embodiments of the disclosure;

FIG. 16 shows a perspective view of the laboratory testing apparatus;

FIG. 17 shows a schematic view of a moveable cart including the interface display screen in accordance with some embodiments of the disclosure; and

FIG. 18 shows a photograph of jacket and hat features formed in tire sealant at a puncture site in a tire.

### DETAILED DESCRIPTION OF THE INVENTION

An automated laboratory testing apparatus for testing the durability of a coating on a substrate and a method of testing the durability of a tire coated with a self-sealing tire sealant for leak-proof performance are provided. As will be understood from the description herein, the disclosed testing apparatus and method provides for a rapid screening test of coating materials including self-sealing tire sealants and reduces or eliminates the need for on-vehicle, over the road testing of self-sealing tires to determine performance. The testing apparatus and method is also capable of testing the impact on sealant pressure-retention performance of both of in-out (insertion-extraction) and rocking (lateral) stresses exerted on the tire by a puncturing object utilizing only a small portion of a self-sealing tire sample. The present testing apparatus and method is therefore dynamic rather than static as it actively simulates the forces exerted by a puncturing object in a puncture site of a tire, as well as road stress exerted on a puncture site after the puncturing object has been removed. Also, the apparatus is capable of testing a self-sealing tire sample under a plurality of different driving speeds (i.e. frequencies) and air temperatures to simulate on-vehicle testing under different vehicle speeds as well as different road and climate conditions.

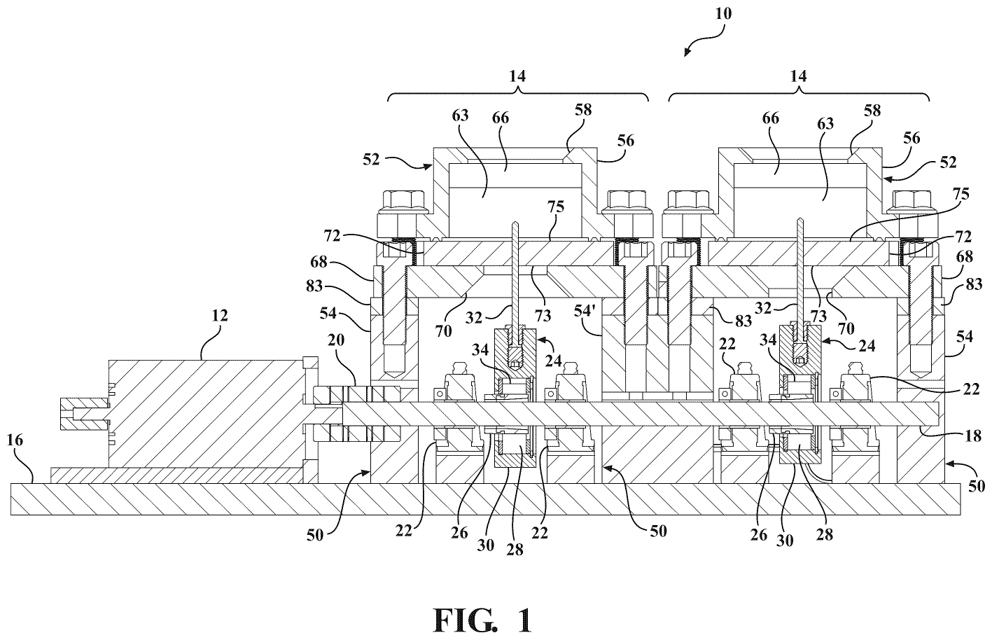

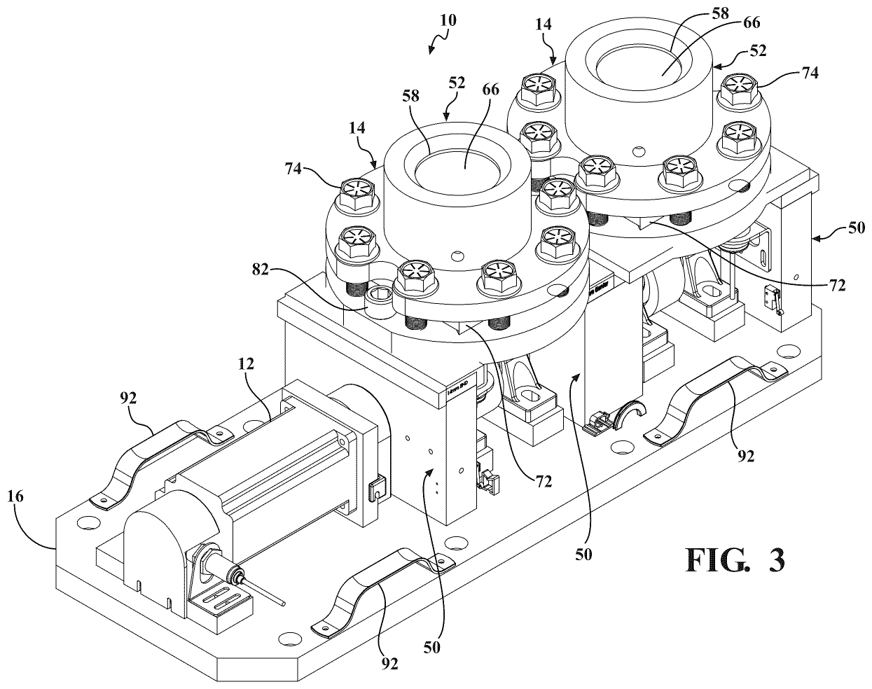

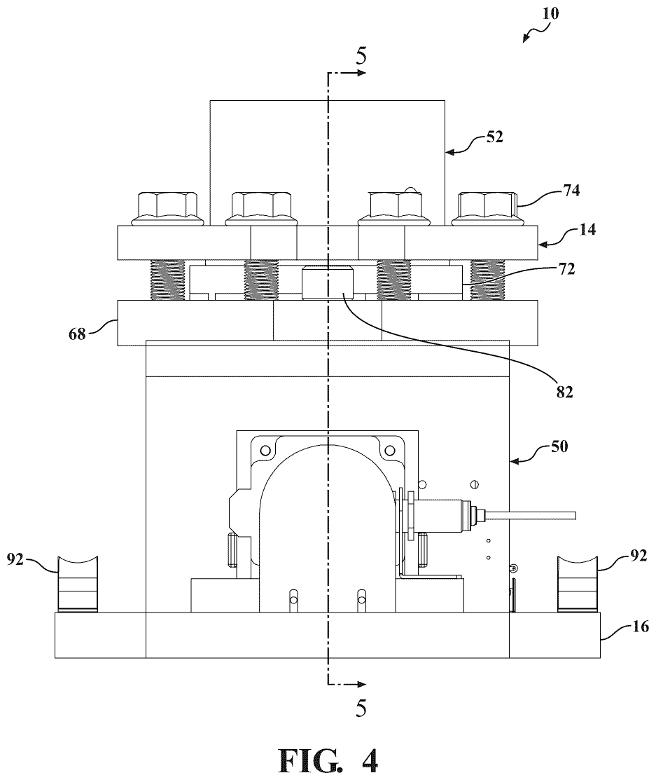

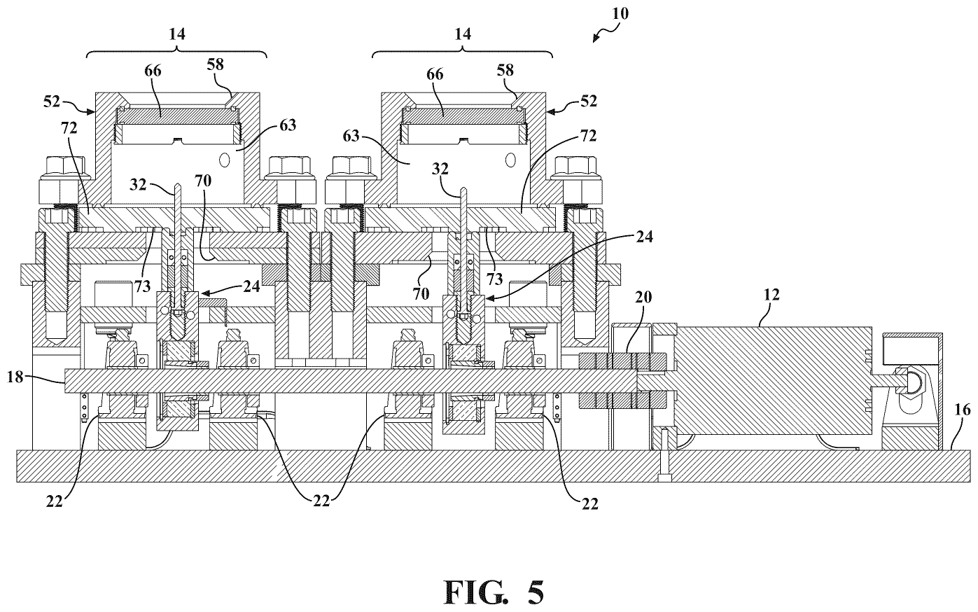

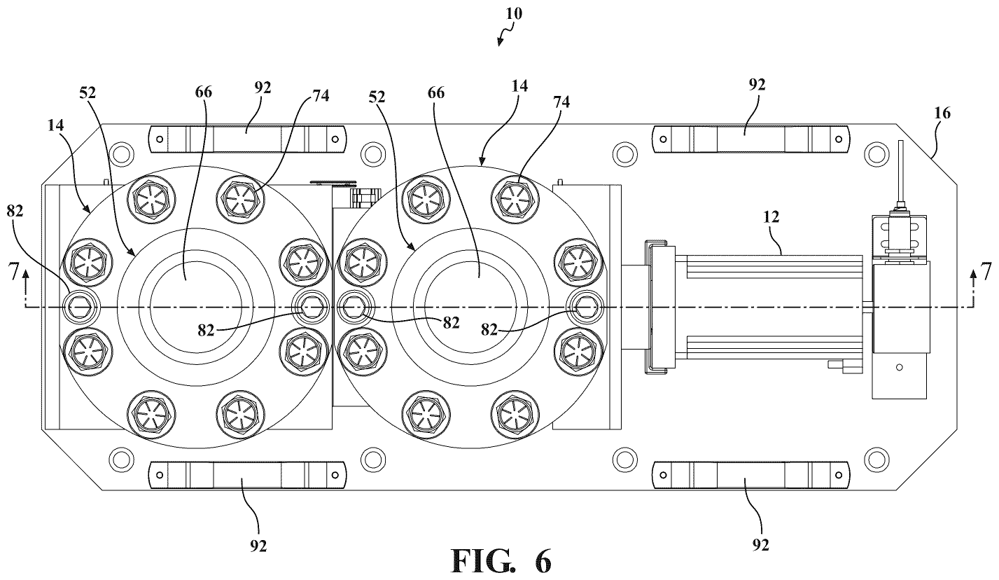

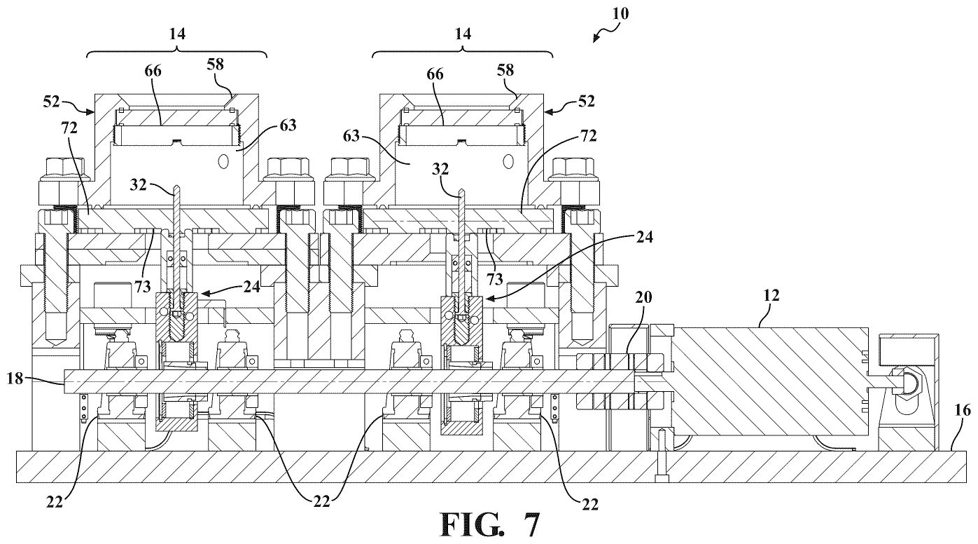

With reference to FIGS. 1-17, wherein like numerals indicate corresponding parts throughout the several views, the automated laboratory testing apparatus (also referred to herein as the testing apparatus or simply as the apparatus) is illustrated and generally designated at 10. Certain features of the testing apparatus 10 are functional, but can be implemented in different aesthetic configurations. The testing apparatus 10 generally includes an actuator 12 and at least one test unit 14 driven by the actuator.

The actuator 12 is mounted on a planar base 16. The actuator 12 is illustrated by example as an electric motor such as a stepper (step) motor or similar. In this embodiment, the actuator 12 is coupled to a driveshaft 18, and the driveshaft connects the actuator to the test unit 14. More particularly, a coupling 20 connects the driveshaft 18 to the actuator 12. The driveshaft 18 is rotatably supported by a plurality of bearing assemblies 22 mounted on the base 16, such as high speed mounted ball bearings. The driveshaft 18 transmits the power of the actuator 12 to the test unit 14 via a cam mechanism. However, it should be understood that other types of actuators and drive arrangements are within the scope of the disclosure, and as such the actuator may be a pneumatic or hydraulic cylinder, an electromagnetic device, or a reciprocating device such as a shaker, and the actuator may drive the test unit via pneumatic lines, hydraulic lines, electromagnetic pulses, and the like.

The test unit(s) 14 is mounted on the base 16 and connected to and driven by the actuator 12. As shown by example, the apparatus 10 may include two of the test units 14 arranged in series on the same driveshaft 18; however, it should be understood that the apparatus only requires one test unit. The two test units 14 allow for the simultaneous testing of two different samples as described in more detail below, thereby increasing the testing capacity and output of the apparatus 10. In other embodiments, the apparatus may include more than two test units. For example, the apparatus may include four test units arranged in series on the same drive shaft, and the apparatus may further include two actuators and associated driveshafts arranged in parallel, with four test units being connected in series to each of the driveshafts. Due to the modularity of the test units 14, the apparatus 10 may be easily expanded to include more or fewer test units. Also, even if more than one test unit is included in the apparatus, not all of the test units have to be used simultaneously. For example, only one of the two test units may be used. Furthermore, a plurality of test units on one driveshaft allows for simultaneous testing of multiple pieces of the same sample with more than one type or size of testing object (nail, screw, punch, etc.), while a plurality of driveshafts each with one or more test units allows for simultaneous testing using independent running conditions (frequencies, amplitudes, cycles) for each driveshaft.

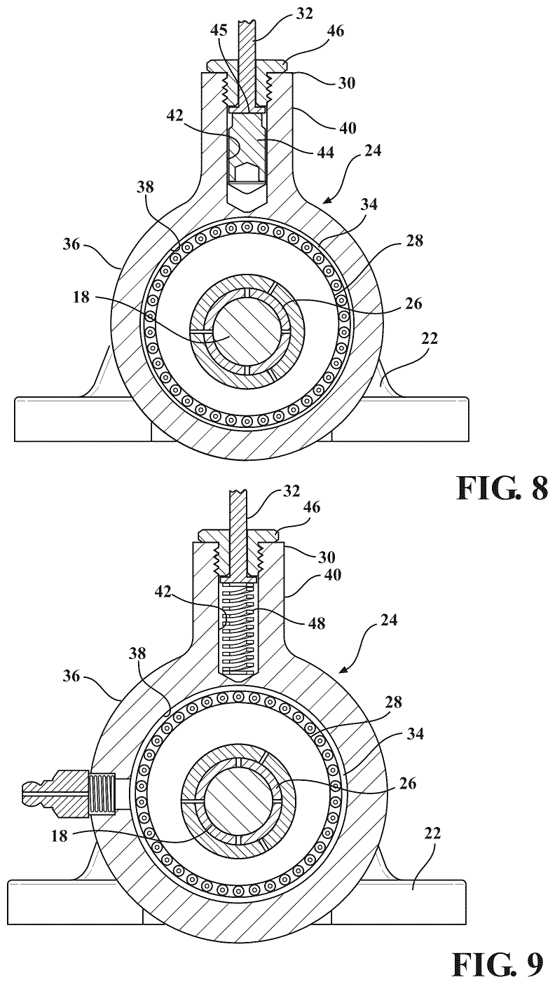

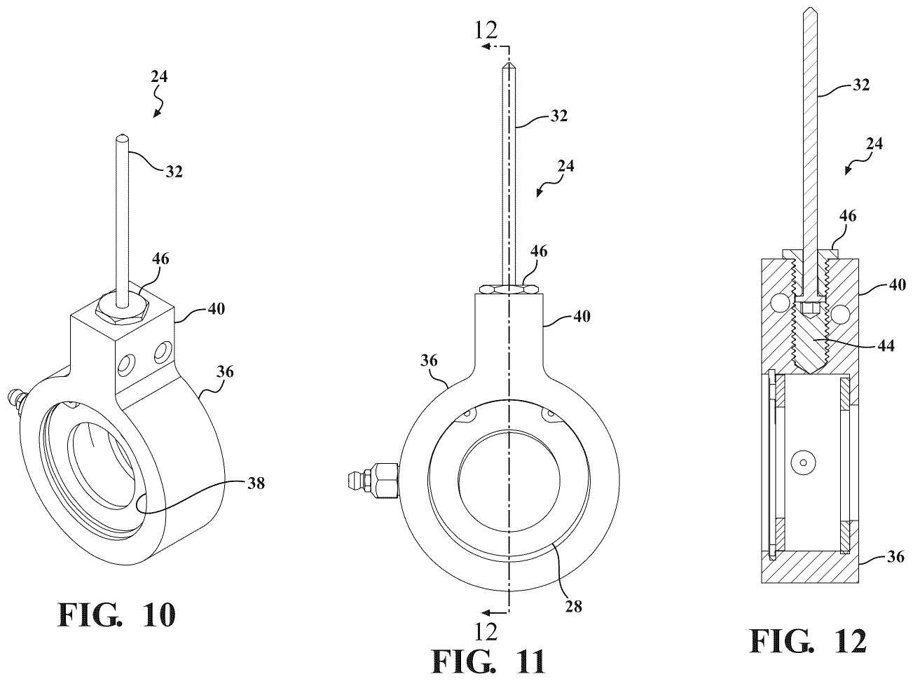

Each test unit 14 includes a cam assembly 24 mounted on the driveshaft 18 by a bushing 26 such as a steel quick-grip screw clamp bushing or similar. The cam assembly 24 includes a cam lobe 28, a follower 30, and a driven member 32. The cam lobe 28 is eccentrically mounted on the driveshaft 18. The cam lobe 28 may be, for example, an offset cam ring having a center that is offset approximately 2 mm (e.g., 2±0.1 mm) from the center of the driveshaft 18, alternatively offset approximately 1.5 mm (e.g. 1.5±0.1 mm) from the center of the driveshaft. The distance of the offset is related to the length of the driven member 32 and the desired degree of motion of the driven member. For example, as will become more apparent below, an eccentricity of 2 mm provides the driven member 32 with a linear motion having an amplitude of ±2 mm and a rotational (wiggling, back-and-forth rocking) motion having an amplitude of ±1.8° from its neutral position. The follower 30 is mounted and held in urged engagement on the cam lobe 28 via a bearing ring 34 such as a steel needle roller bearing or similar. Particularly, the follower 30 includes a circular body 36 having a circular internal opening 38 in which the cam lobe 28 and sandwiched bearing ring 34 are disposed. The follower 30 further includes a linear driving arm 40 that protrudes and extends outwardly from the circular body 36. The driving arm 40 includes a recess 42, and the driven member 32 is held in engagement with the driving arm in the recess. In one arrangement shown in FIG. 8, the driven member 32 is fixedly mounted in the recess 42 by a set screw 44 and locking nut 46. In this arrangement, the set screw 44 is screwed into the recess 42 a certain distance, and the driven member 32 is held in tight engagement against an outwardly facing surface 45 of the set screw 44 by the locking nut 46 which is threaded into the recess 42. The set screw 44 provides hard contact with the driven member 32 that is representative of hard road conditions. On the other hand, in an alternative arrangement shown in FIG. 9, the driven member 32 is flexibly mounted in the recess 42 by a resilient member 48 such as a spring or similar. In this arrangement, the spring 48 is disposed in the recess 42, and the driven member 32 is secured in the recess by the locking nut 46. The spring 48 urges the driven member 32 outwardly away from the driving arm 40 but also allows the driven member to retract. The flexible contact provided by the spring 48 is representative of soft road conditions. Furthermore, the spring 48 is more forgiving during the mounting of test samples (see below), and imposes less undesired stress on the coating of the test sample due to factors such as thickness variation of the test sample. At the same time, the spring force of the spring 48 must be large enough to overcome the force required to move the driven member 32 during dynamic durability testing. For example, a force between approximately 72 N and 163 N may be required to move the driven member 32 during sample testing, and correspondingly the spring 48 may have a spring stiffness between 2.5 and 4.5 lb/mm, more preferably between 2.9 and 3.9 lb/mm, and a maximum load between 27 and 32 lbs, more preferably between 28 and 21 lbs. Further, given a recess 42 length of 24.8 mm, the spring 48 may have a compressed length of between 22 and 24.5 mm, more preferably between 22.4 and 24 mm. In yet another arrangement shown in FIGS. 10-12, a modular cam lobe may be utilized so that the eccentricity can be varied (e.g. by replacing one cab lobe with another having a different eccentricity) to change the in-out displacement of the driven member and to change the rocking angle amplitude.

In some embodiments, the cam assembly 24 is capable of floating and self-adjusting along the axis of the driveshaft 18. Particularly, in certain embodiments floating of the cam assembly 24 is accomplished by setting the cam width at approximately 1.25 inches and the bearing assembly 22 width at approximately 1.00 inches. Floating and self-adjusting of the cam assembly 24 provides for improved alignment of the driven member 32 and adjusts for varying locations of the driven member. This aides in reducing any potential premature coating failure in a test sample (see below) that may be caused by excessive stresses in the coating introduced by undesired tilting of the driven member 32, thereby improving testing consistency.

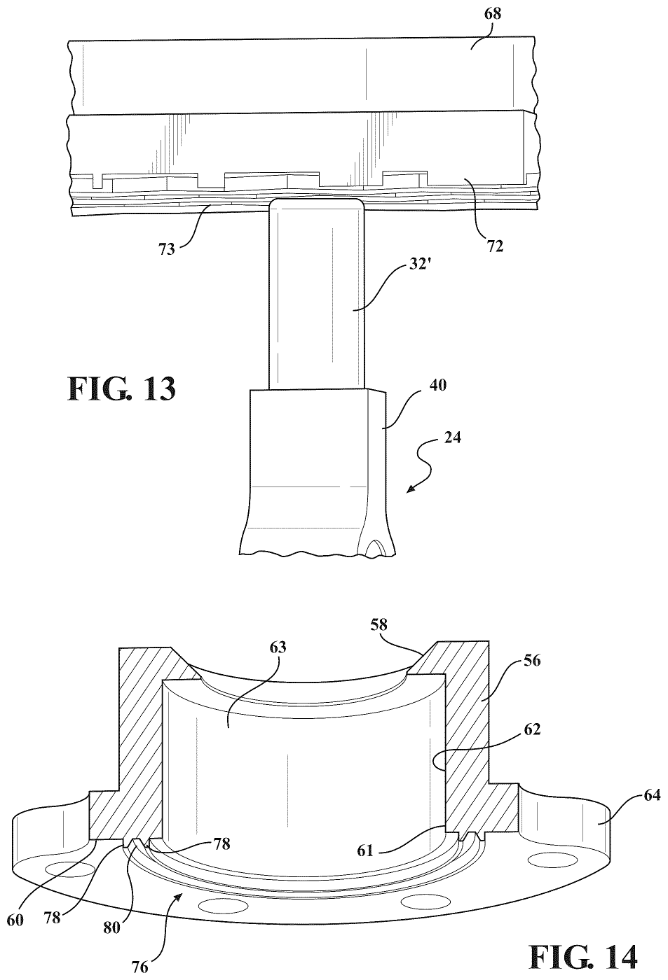

The driven member 32 held in the driving arm 40 of the cam assembly 24 is interchangeable by screwing and unscrewing the locking nut 46. The driven member 32 may be chosen from a set including both puncturing object(s) and blunt, non-sharp object(s). The puncturing object may be a nail, a screw, and/or any other member having a point such as but not limited to a member that includes or simulates a shard of glass. The driven member 32 is shown by example as a nail in FIGS. 8-12, or as a blunt object as shown by example in FIG. 13. The blunt object may be a punch 32′ in the form of a cylinder having a generally flat end surface, or may be any other object having an end that is not sharp and that generally will not puncture through a substrate. The apparatus 10 may also include a plurality of each type of puncturing objects and/or blunt objects, such as a plurality of nails having diameters ranging from 1 mm to 5 mm and a plurality of screws having diameters ranging from 1 mm to 5 mm. The range of sizes of nails and/or screws allows for the testing a substrate's ability to withstand puncturing by a variety of sizes of puncturing objects as described in more detail below.

In some embodiments, the driving arm that holds the driven member 32 may be held and guided by a fixture to control the depth and directionality of the driven member 32 as it is driven through a test sample (see below). Particularly, the fixture may be cylindrical and may have a through-hole that corresponds in shape to the driving arm. The driving arm is (partially) inserted into the through-hole such that the through-hole guides the motion of the driving arm as it moved in a reciprocating, back-and-forth motion.

In the embodiment shown in FIG. 1, the cam assembly 24 of one of the two test units 14 is offset 180 degrees in a circumferential direction of the driveshaft 18 relative to the cam assembly of the other of the two test units. More specifically, the cam lobe 28 of one of the cam assemblies 24 is rotated 180 degrees on the driveshaft 18 relative to the cam lobe of the other cam assemblies. The 180-degree offset between the two cam lobes reduces imbalance in the system and any resulting vibration. Further, the offset results in the driven member 32 of one of the cam assemblies 24 being at its highest point (farthest away from the driveshaft 18) when the driven member of the other cam assembly is at its lowest point.

Each test unit 14 further includes a support 50 and a pressure chamber assembly 52. The support 50 extends vertically from the base 16, flanks the cam assembly 24, and supports the pressure chamber assembly 52. The support 50 may comprise a single member, or as shown by example, may include a pair of stanchions in the form of vertical block or wall members 54, 54′ that are disposed on opposite sides of the cam assembly 24. Particularly, each block member 54, 54′ includes an opening 55 through which the driveshaft 18 extends, two of the bearing assemblies 22 are disposed between the two block members 54, 54′ of the support 50, and the cam assembly 24 is sandwiched between the two bearing assemblies. The pressure chamber assembly 52 is mounted on each of the two block members 54, 54′ and is suspended between the block members and above the cam assembly 24. Furthermore, as shown in FIG. 1, the pressure chamber assemblies 52 of two adjacent test units 14 may share a common block member 54′ between them, in which case the common block member is wider in a longitudinal direction of the driveshaft 18 than the block members 54 on the ends that are not disposed between two pressure chamber assemblies. In some embodiments, resilient members such as coil springs may be inserted between the support 50 and pressure chamber assembly 52 to control the weight (e.g. 40 pounds) of the pressure chamber assembly when it is assembled onto the support., thereby reducing potential premature failure of a test sample that may be caused by the driven member 32 during assembly/installation (see below).

Turning to FIGS. 1, 2, 14, and 15, the pressure chamber assembly 52 includes a main body 56 having a monitoring window 58 an open end 60 including an opening 61, and an inner chamber wall 62 adjacent the opening and defining a pressure chamber 63 within the main body. The main body 56 may be a generally hollow cylinder with an annular flange 64 at the open end 60. The monitoring window 58 may be a generally circular opening opposite the open end 60, or alternatively may be disposed along a side or at the bottom of the main body, and may include a sight glass 66 formed of a polycarbonate plate or similar. In another embodiment, the entire main body may constitute the viewing window, and the main body may comprise a transparent polycarbonate material or similar, i.e. the whole main body being transparent and thereby constituting the viewing window. The pressure chamber assembly 52 further includes a clamping member 68. The clamping member 68 may be in the form of a disc having a central opening 70. The clamping member 68 cooperates with the flanged open end 60 of the main body 56 to sandwich a test sample substrate 72 between the clamping member and the main body in order to close the pressure chamber 63 with the surface of substrate including a coating layer thereon faces the pressure chamber. The central opening 70 circumscribes a testing area of the test sample substrate 72 that is sandwiched in the pressure chamber assembly 52, and the coating layer in the testing area of the substrate is inside of the pressure chamber. The central opening 70 is therefore sized to be large enough to allow for leak spray detection as described in more detail below, as well as to not cause any interference with the driven member 32, while being sized to be small enough to restrict any deformation of the test sample substrate under pressure during testing (e.g., doming of the substrate whereby the pressure in the pressure chamber causes the substrate to bulge outwardly away from the pressure chamber). The main body 56 is held together with the clamping member 68 by a plurality of fasteners such as threaded bolts 74 that are inserted through apertures in the flange 64 of the main body 56 and threaded into corresponding threaded apertures in the clamping member 68. In some embodiments, the main body 56 includes a seal 76 circumscribing the opening 61. Particularly, the seal 76 may include a pair of concentric annular ridges 78 forming an annular groove 80 between the ridges. The annular ridges 78 bite into the side of the substrate 72 that includes a coating layer and faces the main body when the substrate is sandwiched and clamped between the clamping member 68 and main body 56 to obtain an air-tight seal of the pressure chamber 63. When the main body 56 and clamping member 68 of the pressure chamber assembly 52 are assembled together with a test sample substrate 72 sandwiched therebetween, the pressure chamber assembly can be mounted on the support 50 by other fasteners such as threaded bolts 82 that extend through other apertures in the flange 64 of the main body 56 and in the clamping member 68, and thread into a threaded aperture in each of the block members 54, 54′ of the support 50.

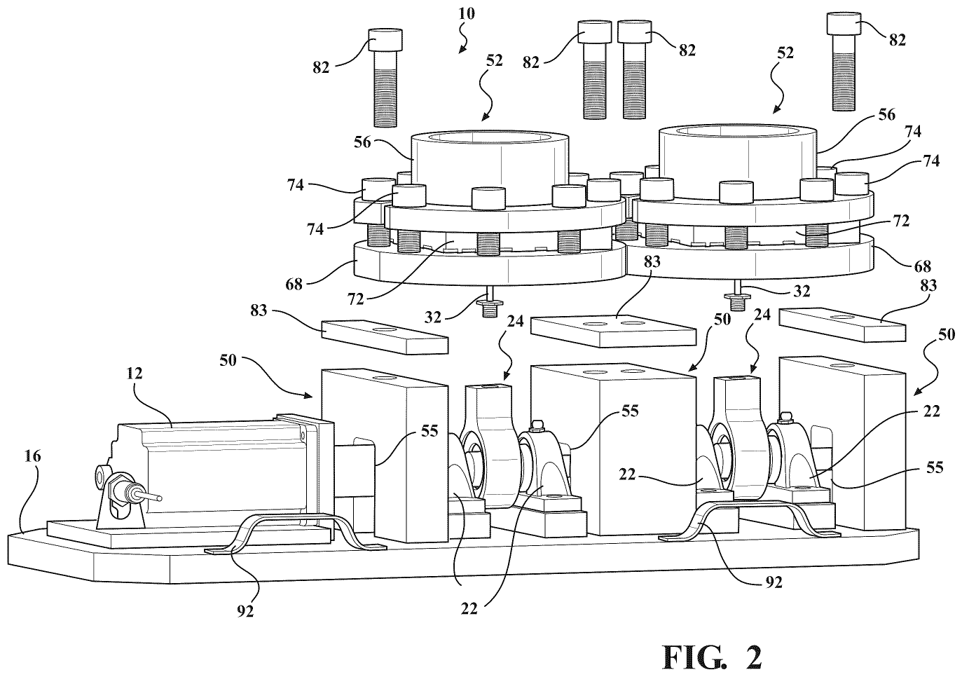

Optionally, an insert 83 may be disposed between the support 50 and the clamping member 68 in order to adjust the height of the pressure chamber assembly 52 relative to the cam assembly 24 as shown in FIGS. 1 and 2. The insert 83 may be a plate or other planar member that is formed of a generally rigid, non-resilient material. The apparatus 10 may include more than one size of insert, and the use/non-use and choice of which insert to use depends on the thickness of the test sample substrate 72 in order to maintain the same penetration length of the driven member 32 (when the driven member is a puncturing object) from the outer surface (e.g. tread surface) of the test sample substrate to the tip of the driven member punctured into the test sample substrate. For example, the penetration length of the driven member 32 may be kept constant at 40 mm. In this case, a test sample substrate having a thickness of 16.5 mm requires an insert having a thickness of 8.0 mm, a test sample substrate having a thickness of 19.5 mm requires an insert having a thickness of 5.0 mm, and a test sample substrate having a thickness of 24.5 mm does not require an insert, i.e. no insert is used.

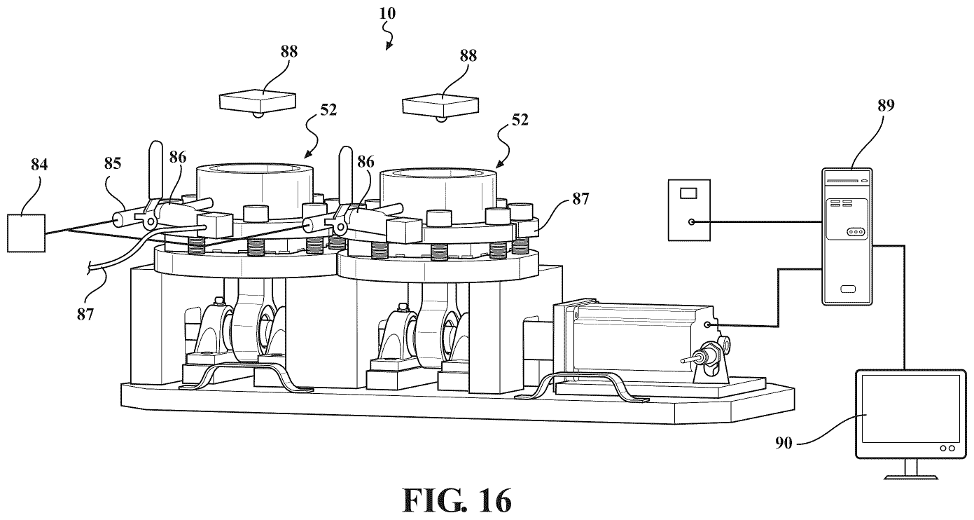

With reference to FIG. 16, the apparatus 10 may include an air inlet/outlet system including a source of compressed air 84 such as an air compressor (and associated air reservoir tank) that is in fluid communication with the pressure chamber 63 of the pressure chamber assembly 52 via an air supply line 85. One or more valves 86 such as solenoids may be connected to the supply line 85 for charging the pressure chamber 63 with compressed air from the air compressor and/or discharging pressurized air in the pressure chamber by releasing it to the atmosphere. Additionally, one or more pressure regulators and/or pressure gauges (not shown) may be fluidly connected to the air supply line. The apparatus 10 may further include a pressure sensor 87 for monitoring the air pressure in the pressure chamber 63. By way of example, the pressure sensor 87 may be attached to the air inlet valve 86 of the pressure chamber 63 as shown in FIG. 16. Alternatively, the pressure sensor may be disposed within the pressure chamber, or may be a non-contact sensor such as an ultrasonic pressure sensor that is installed outside the pressure chamber and can detect pressure loss in the pressure chamber from the outside. The pressure sensor 87 may be any suitable sensor known in the art capable of measuring pressure levels and/or pressure loss.

A camera 88 may be included to monitor the movement of the driven member 32 and to visually monitor the interaction between the driven member and the test sample substrate 72. The camera lens of the camera 88 may be located at the monitoring window 58 of the pressure chamber assembly 52, and/or may be located adjacent the clamping member 68 to monitor the test sample substrate 72 from outside of the pressure chamber.

The apparatus 10 may additionally include a control and data acquisition system that includes one or more of a controller (CPU) 89 and a user interface (human-machine interface) 90 including one or more input/output devices such as a display, keyboard, mouse, printer, and the like that are electrically connected to the controller. The controller 89 is electrically connected to one or more of the actuator 12, the pressure sensors 87, and the at least one valve 86 in order to control the actuator and test units and to process data received from the monitoring of the test units. In some embodiments, the user interface 90 is a touchscreen display that visually displays information and allows for user input by contacting the screen. The control and data acquisition system allows for the setting and control of various parameters including the moving frequency/speed, the amplitude, and the number of cycles of the driven member 32 via control of the actuator 12, as well as a pressure drop shutoff set point at which the actuator is deactivated. Additionally, the system may include an emergency stop control that allows the apparatus 10 to be manually shut off at any time, by, for example, toggling a control button. The control and data acquisition system also may receive pressure data from the pressure sensors 87 to monitor, display, and store the pressure level in the pressure chamber(s) during testing, and can detect pressure loss during testing. The control and data acquisition system also may receive, display, and store visual information provided by the camera, if present. The apparatus 10 including the control and data acquisition system and the test unit(s) may be provided on a moveable cart 91 as shown by example in FIG. 17 so that the entire apparatus may be easily transported, such as if the apparatus is moved into and out of an environmental chamber. Alternatively, the control and data acquisition system may be separately stored on a moveable cart or stationary workstation, while the test units 14 on the base 16 may be moved to various locations. For example, the base 16 may include lifting handles 92 so that the actuator 12 and test units 14 on the base 16 may be lifted and moved from one location to another.

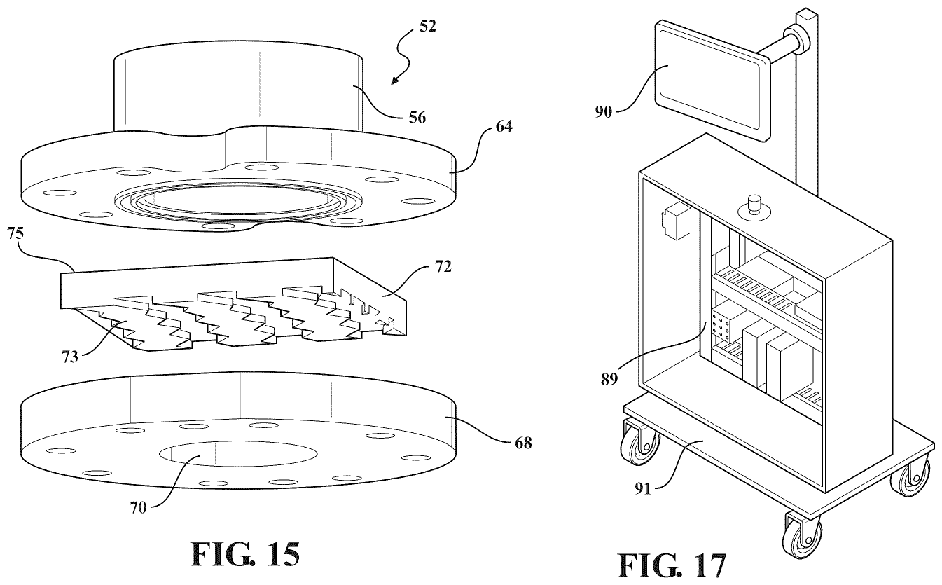

As shown by example in FIG. 15, the test sample substrate 72 may be a tire sample cut from the tread surface (as opposed to the sidewalls) of a whole tire, the tire sample including a tire tread 73 on one (outer) surface and a coating layer 75 of self-sealing tire sealant on an opposite inner surface. The tire sample may be cut into a generally square shape and may have a dimension of approximately 146.1 mm×146.1 mm (5.75″×5.75″). However, the test sample substrate is not limited to these particular dimensions and only need be large enough to cover over and extend beyond the periphery of the opening 61 at the open end 60 of the main body 56 of the pressure chamber assembly 52. In any event, it is apparent that the test sample substrate 72 may be a relatively small portion of a tire, and thus economical for evaluating sealant performance of self-sealing tire sealants, as opposed to on-vehicle testing which requires the use of four complete tires. The test sample substrate is not limited to tire samples, however, and may be another substrate with or without a coating layer thereon. Further, the coating layer is not limited to self-sealing sealants, and may be another type of coating material. For example, the test sample substrate may be a tire sample on which a polymer foam is coated (i.e. a sample of a “run quiet tire”) for the acoustic effect of noise dampening, and durability of the adhesion of the noise dampening coating layer to the inside surface of the tire sample may be tested. Additionally, the test sample substrate may be cut out of a tire that already includes the coating layer on the inner surface (e.g., a manufactured self-sealing tire), or the test sample substrate may be cut from a tire that does not include a self-sealing sealant layer, and the self-sealing sealant may be coated on the non-tread surface of the sample after it is cut from the tire. In any event, the quantity of material necessary to obtain a tire sample substrate 72 is small.

By way of example, the apparatus 10 may be used to test the durability of a test sample 72 of a tire including a layer of self-sealing sealant thereon. As mentioned above, the testing apparatus 10 may be used to test two (or more than two, depending on the number of test units 14) samples simultaneously using the two test units as shown in FIG. 1. For sake of explanation, the discussion of the test procedure will generally be in reference to one test sample substrate 72 and one test unit 14, and it should be understood that the test procedure applies equally to all of the test units. An exemplary test procedure may generally include assembling the pressure chamber assembly, inserting a nail into the test sample, attaching the pressure chamber assembly to the test unit, running a durability test for the nail at room, hot, and cold temperatures and monitoring for a leak, extracting the nail and checking for a leak, running a durability test with the nail removed by punching the tread surface of the tire sample near the puncture site to simulate driving on the tire with the nail removed from the tire, and conducting a storage test by putting the test sample held in the test unit through a thermal cycle including room, hot, and cold temperatures, and again checking for a leak.

More particularly, once a desired tire sample 72 is obtained, the pressure chamber assembly 52 is assembled by sandwiching the tire sample 72 between the main body 56 and the clamping member 68 with the tire tread 73 of the tire sample facing the clamping member and the layer of sealant 75 on the inner surface of the tire sample facing the pressure chamber 63, and inserting the bolts 74 through the appropriate apertures in the main body and clamping member. As discussed above, the tire sample 72 is sized so that it completely covers over the opening 61 in the main body 56 and extends beyond the periphery of the opening, but is generally within the outer boundaries of the flange 64 of the main body and the periphery of the clamping member 68. The central opening 70 in the clamping member 68 is also completely overlapped by the tire sample 72. A driven member 32, in this case a puncturing object such as a nail or screw (a nail is shown by example in the drawings) is inserted through the central opening 70 of the clamping member 68 and punctured through the tire tread 73 of the tire sample 72 so that the nail contacts the tire sample and the tip of the nail extends beyond the tire sample and into the pressure chamber 63. The nail may be driven into the tire sample 72 to a controlled depth using a hammer or mallet, or the nail may be driven into the tire sample using a universal tensile test machine, a bench Amber press, or any other suitable means. Once the nail is in inserted through the tire sample 72, the pressure chamber assembly 52 is mounted onto the support 50 and secured with two bolts 82, one per block member 54 of the support. In the case that coil springs are inserted between the pressure chamber assembly 52 and the support 50, the springs reduce the amount of load exerted on the driven member 32 due to the weight of the pressure chamber assembly, thereby reducing the possibility of premature failure of the test sample by alleviating any potential excessive stress in the test sample introduced by the driven member punctured into the test sample. Alternatively, the nail or other puncturing object may be driven into the tire sample after the pressure chamber assembly 52 is mounted on the support 50. Also, the head of the nail is secured to the driving arm 40 of the cam assembly 24 using the locking nut 46. Next, the pressure chamber 63 is pressurized by filling the pressure chamber with compressed air from the source of compressed air 84, to pressurized the pressure chamber to a pressure of, for example, 36 psi. The sealed pressure chamber assembly with the tire sample mounted therein is capable of sustaining a pressure generally in the range of 30 to 50 psi, which covers the typical inflation pressures of vehicle tires. After pressurization, the test parameters may be set through the user interface. The test parameters may include but are not necessarily limited to the nail moving frequency, amplitude, and number of test cycles based on factors such as the diameter of the tire, driving speeds that are to be simulated, road conditions that are to be simulated, and driving distances to be simulated at each driving speed to mimic an on-the-road test. The test parameters may also include a shut-off set point pressure at which the test run will automatically stop if the pressure in the pressure chamber 63 drops below the set point pressure. Once the test parameters are set, the controller 89 actuates the actuator 12 to drive the nail and cause the nail to move within the tire sample in both an oscillating linear back-and-forth motion and an oscillating rocking motion. Specifically, the actuator 12 rotates the driveshaft 18, which in turn rotates the cam lobes 28. Due to the eccentricity of the cam lobes 28, the cam lobes move the follower 30 in an up-and-down motion and simultaneously in a slight rocking motion. Movement of the follower 30 drives the nail mounted in the driving arm 40 of the follower 30 in the same oscillating linear and an oscillating rocking motions. The motions of the nail in the tire sample simulate the moving forces that would be applied to the nail punctured into the tire as the tire rotates over the nail on the road, and test the durability of self-sealing sealant that surrounds the nail at the puncture site. The pressure in the pressure chamber 63 is monitored while the nail is driven to check that no pressure loss has occurred. Also, the inner surface of the tire sample in the pressure chamber 63 can be visually monitored through the monitoring window 58, and a camera can be used to monitor and/or record activity in the pressure chamber at the puncture site, or activity at the puncture site on the outside of the pressure chamber, i.e. on the tire tread side of the puncture site. After the desired number of cycles are reached, the actuator 12 is stopped if no pressure loss was detected by the pressure sensor 87. The pressure chamber assembly 52 is then dismounted from the support 50, and optionally the no-leak performance of the sealant may be tested using a spray method by spraying a leak detection liquid (e.g., soapy water, salt water) onto the puncture site (with the nail still inserted) and inspecting for the production of growing bubbles around the puncture site. Next, the nail is removed from the tire sample 72 and the puncture site may again be checked for any air leaks. With the nail removed, the tire sample can then be tested for sealant pressure retention performance by simulating a self-sealing tire periodically interacting with the ground and measuring any pressure loss over time. Specifically, another driven member that is a blunt object 32′ such as a punch is mounted onto the cam assembly 24, and the pressure chamber assembly 52 is again mounted on the support 50 such that the blunt object is contactable with the tire tread 73 of the tire sample 72 in a region of the tire sample including the puncture site. The test parameters are again set using the user interface 90, and the actuator 12 is actuated to drive the blunt object and to cause the blunt object to move so that it periodically punches the tire tread of the tire sample proximate to the puncture site. The pressure in the pressure chamber 63 is continuously monitored while the blunt object is driven to check for any pressure drops indicating air leakage at the puncture site. Also, the inner surface of the tire sample in the pressure chamber 63 can be visually monitored through the monitoring window 58, and the camera 88 can be used to monitor and/or record activity in the pressure chamber at the puncture site, or activity at the puncture site on the outside of the pressure chamber, i.e. on the tire tread side of the puncture site. Once the desired number of cycles have been completed, the actuator is shut off.

The test procedure discussed above may be conducted at room temperature. Optionally, the test procedure can be conducted at one or more of room temperature, a cold temperature (e.g. less than 20° C. and as low as −50° C., such as −50° C., more preferably −30° C., even more preferably −20° C.), and a hot temperature (e.g. greater than 20° C. and as high as 150° C., such as 150° C., more preferably 100° C., even more preferably 70° C.) as well as at different humidity levels by conducting the tests with the apparatus 10 located in an environmental chamber that allows for adjustment of temperature and humidity to simulate various climate and seasonal weather conditions. Additionally, after the above test procedure is conducted, the apparatus 10 including the mounted tire sample, or simply the pressure chamber assembly with the mounted tire sample, may be subjected to a thermal cycle in an environmentally controllable chamber while further monitoring the pressure in the pressure chamber and checking for leaks at the puncture site. The thermal cycle may range from −50° C. to 150° C., more preferably from −30° C. to 100° C., even more preferably from −20° C. to 70° C. In addition to temperature variation, various real-world road conditions such as rain, snow (salt treated road), mud, etc. can be simulated by spraying various substances on the tread surface of the tire sample, such as, for example, a liquid spray of soap or salt water, a liquid spray mixed with ground calcium carbonate, or a liquid spray mixed with dust.

The following two tables provide exemplary test procedure steps and test conditions.

TABLE 1
Exemplary Test Procedure Simulating a Cold Road Test

| | | | Equivalent Road Test | | | | Lab Test | |
|---|---|---|---|---|---|---|---|---|
| | Pressure | Temperature | Distance | | Speed | | Test Freq | # of |
| Nail | (PSI) | (° C.) | km | mile | km/h | mph | hz | Cycles |

Test set up: assemble sample-pressure chamber, pressurize, puncture

| In | 36 | −20 | 1000 | 621 | 90 | 56 | 12 | 482,240 |
|---|---|---|---|---|---|---|---|---|
| In | 36 | −20 | Disconnect pressure chambers from camshaft; Check for leak with soap | | | | | |
| Out | 36->45 | Room | If no leak, gradually extract nails and check for air leak with soap | | | | | |
| | | | 1. Spray & check leak with partial (2 cm) nail extraction | | | | | |
| | | | 2. Spray & check leak after full extraction | | | | | |
| Out | 36 | ROOM | If no leak, connect the punch, and the pressure chambers; run the punching | | | | | |
| | | | durability test; set trigger pressure at 22 PSI | | | | | |
| Out | 36 | ROOM | 20 | 12 | 45 | 28 | 6 | 9,645 |
| Out | 36 | ROOM | 300 | 186 | 90 | 56 | 12 | 144,672 |

| | | | |
|---|---|---|---|
| Out | 36 | ROOM | Disconnect pressure chambers from camshaft; check for air leak with soap; |
| | | | Program the environmental chamber to run a cold-hot thermal cycle |
| Out | 36->28 | −20 | Cool samples/pressure chambers at −20° C. and monitor for leak; |
| Out | 28->45 | 70 | Check for leak with soap; If no leak, rise temperature to 70° C. and monitor for leak |
| Out | 45->36 | ROOM | Check for leak with soap; Record findings |

TABLE 2
Exemplary Test Procedure Simulating a More Stringent Cold Road Test

| | | | Equivalent Road Test | | | | Lab Test | |
|---|---|---|---|---|---|---|---|---|
| | Pressure | Temperature | Distance | | Speed | | Test Freq | # of |
| Nail | (PSI) | (° C.) | km | mile | km/h | mph | hz | Cycles |

Test set up: assemble sample-pressure chambers, spray the sealant side of the sample with soap and dip the
nail in soap, pressurize pressure chambers, puncture the sample

| In | 36 | Room | 6,437 | 4,000 | 90 & 45 | 56 & 28 | 12 & 6 | 3,065,408 |
|---|---|---|---|---|---|---|---|---|
| In | ~45 | 70 | 3,219 | 2,000 | 90 & 45 | 56 & 28 | 12 & 6 | 1,532,704 |
| In | ~28 | −20 | 3,219 | 2,000 | 90 & 45 | 56 & 28 | 12 & 6 | 1,532,704 |
| Out | 28->36 | −20 | Disconnect pressure chambers from camshaft; Check for leak with soap; | | | | | |
| | | | If no leak, gradually extract nails and check for air leak with soap | | | | | |
| | | | 1. Spray & check leak with partial (2 cm) nail extraction | | | | | |
| | | | 2. Spray & check leak after full extraction | | | | | |
| Out | 36 | ROOM | If no leak, connect the punch, and the pressure chambers; run the | | | | | |
| | | | punching durability test | | | | | |
| Out | 36 | ROOM | 20 | 12 | 45 | 28 | 6 | 9,645 |
| Out | 36 | ROOM | 300 | 186 | 90 | 56 | 12 | 144,672 |

| | | | |
|---|---|---|---|
| Out | 36 | ROOM | Disconnect pressure chambers from camshaft; check for air leak with |
| | | | soap; Program the environmental chamber to run a cold-hot thermal cycle |
| Out | 36->28 | −20 | Cool samples/pressure chambers at −20° C., and soak the sample at −20° |
| | | | C. for 12 hours |
| Out | 28->45 | 70 | Check for leak with soap; If no leak, rise temperature to 70° C. and soak |
| | | | the sample at 70° C. for 12 hours |
| Out | 45->36 | ROOM | Cool the sample to room temperature, wait 2 hours to check for leak with |
| | | | soap; Record findings |

The test frequency for a tire sample can be estimated based on the outside perimeter of the tire from which the sample is cut and the desired simulated road testing speed using the following formula:

$$f = \frac{v}{3.6 p}$$

where f is the test frequency in Hz, v is the desired road test speed in km/h, and p is the outside perimeter of the tire in meters. The following table is an illustrative example of the correlation between test frequency and equivalent driving speed for a tire having a perimeter of 2.1 meters, calculated from the formula above.

TABLE 3
Test Frequency Associated with Driving Speeds at p = 2.1 m

| Test Frequency | Equivalent driving | Equivalent driving |
|---|---|---|
| (Hz) | speed (km/h) | speed (mph) |
| 20 | 150 | 93 |
| 17 | 130 | 81 |
| 16 | 120 | 75 |
| 13 | 100 | 62 |
| 12 | 90 | 56 |
| 11 | 80 | 50 |
| 10 | 75 | 47 |
| 9 | 70 | 43 |
| 7 | 50 | 31 |
| 6 | 45 | 28 |
| 5 | 37 | 23 |
| 4 | 30 | 19 |
| 2 | 15 | 9 |
| 1 | 7 | 5 |

The rocking amplitude of a puncturing object (e.g. nail) can be estimated based on the road conditions, the mass of a vehicle, and the road test speed. Typically, a larger amplitude should be associated with a lower frequency (e.g. ±3° at 6 Hz) to simulate a vehicle running under rough road conditions such as on gravel roads. On the other hand, a smaller amplitude should be used in combination with a higher frequency (e.g. ±1° at 12 Hz) to simulate a vehicle running under smooth road conditions such as on freeways.

The equivalent driving distance for a tire sample can be estimated based on the outside perimeter of the tire from which the sample is cut can be calculated using the following formula:

$$d = n * p / 1000$$

where d is the equivalent driving distance in km, n is the number of test cycles, and p is the outside perimeter of the tire in meters.

TABLE 4
Number of Test Cycles Associated with
Driving Distances at p = 2.1 m

| | |
|---|---|
| Number of | Equivalent driving distance |

| Test Cycles | (km) | (Miles) |
|---|---|---|
| 766,352 | 1,609 | 1,000 |
| 153,270 | 322 | 200 |
| 76,635 | 161 | 100 |
| 38,318 | 80 | 50 |

The pressure level set in the pressure chamber should be based on the application of the tire and should be approximately 2.5 bar for a passenger tire.

The test parameters may also be varied to test for small, very slow leaks over a time period of days.

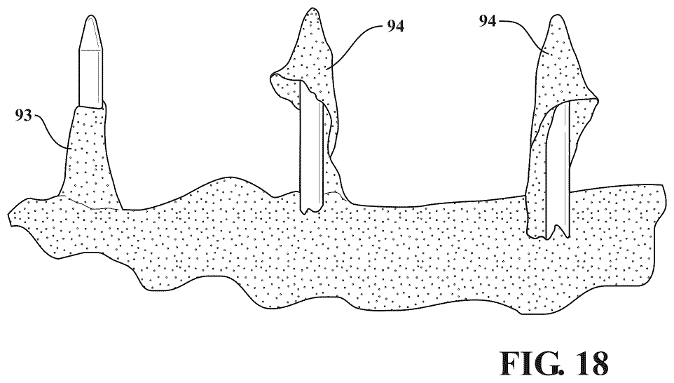

Turning to FIG. 18, two different sealant failure modes are pictured. Particularly, there are two types of sealant failures that may result from the testing performed by the testing apparatus. For example, as shown on the left-hand side, the oscillating motion of a driven member such as a nail may form a “jacket” feature 93 in the tire sealant, i.e. the sealant forms a jacket or sleeve around the shaft of the nail as it is lifted from the inner surface of the tire sample. Alternatively, as shown in the middle and right-hand side, a driven member such as a nail may form a “hat” feature 94 in the tire sealant, i.e. the sealant forms a hat that covers the tip at the end of the nail.

While the pressure chamber assembly is shown as being mounted above the cam assembly with the driven member interacting with the test sample substrate from below (to simulate interactions between the road and the driven member in the tire), the pressure chamber assembly and cam assembly may have other orientations, such that the driven member of the cam assembly interacts with the pressure chamber assembly from above, from the side (horizontally), or at an angle between horizontal and vertical. The various orientations may be used in the simulation of different road conditions or to provide alternative means to monitor for leaks. For example, if soap/soapy water is sprayed onto the substrate to monitor for air leaks around the puncture site, the driven member should interact with the tire substrate from above, so that the soap is disposed on an upper (rather than lower) surface of the substrate. Also, if small particles are used to simulate the impact of dirt on the puncture site, a from-above orientation should also be used so that the dirt stays on the upper surface of the substrate. Further, when a tire spins on a road under different conditions (rain, snow, and/or mud that include coating deteriorating chemicals), it is possible that abrasion particles combined with the coating deteriorating chemicals penetrate the puncture site and reach the coating-tire interface on the inner surface of the tire. When the tire sample is disposed above the driven member, little to no spray that is placed on the tire tread surface during a liquid spray test reaches the coating-tire interface because the tire tread is facing downwards. This configuration gives the least conservative performance results for testing the durability of the coating under these road conditions simulated with the liquid spray. On the other hand, when the tire sample is disposed below the driving member, the tire tread faces upwards and spray placed on the tire tread surface has the maximum ability to reach the coating-tire interface. This configuration gives the most conservative performed results for testing the durability of the coating to various chemicals contained in the liquid spray. Further, the configurations in which the tire sample is horizontally to the side of the driven member or tilted at an angle give results that fall in between the top and bottom configurations as the liquid spray may partially reach the coating-tire interface.

Additionally, the abrasive particles and chemicals that may be contained in the liquid spray have been found to deteriorate organic coatings used on the inner tire surface, whereas silicone coatings have been found to be insensitive to these materials. Hence, the orientation of the tire sample to the driven member may not be as significant for silicone coatings as for organic coatings.

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

1. An automated laboratory apparatus for dynamically testing the durability of a coating, the apparatus comprising:
an actuator;
a driveshaft coupled to the actuator; and
a test unit including a cam assembly, a support flanking the cam assembly, and a pressure chamber assembly;
the cam assembly being mounted on the driveshaft and including:
a cam lobe eccentrically mounted on the driveshaft;
a follower in urged engagement with the cam lobe, the follower including a circular body surrounding the cam lobe, and a driving arm protruding from the circular body; and
a driven member held in engagement with the driving arm of the follower of the cam assembly;
the pressure chamber assembly being mounted on a support and aligned with the cam assembly, the pressure chamber assembly including:
a main body including a monitoring window, an open end including an opening, and an inner chamber wall adjacent the opening and defining a pressure chamber within the main body; and
a clamping member including a central opening, wherein the clamping member and main body are adapted to sandwich a substrate including the coating therebetween to close the pressure chamber with the coating facing inside the pressure chamber;
wherein the driven member extends through the central opening in the clamping member and is contactable with the substrate; and
wherein rotation of the driveshaft drives one or both of an oscillating linear and an oscillating rocking motion of the driven member via the cam assembly.

2. The automated laboratory apparatus according to claim 1, wherein the driven member is a puncturing object or a blunt object.

3. The automated laboratory apparatus according to claim 2, wherein the puncturing object is a nail, a screw, or a member having a point.

4. The automated laboratory apparatus according to claim 1, any one wherein the main body of the pressure chamber assembly includes a seal circumscribing the opening, the seal including a pair of concentric annular ridges forming an annular groove therebetween.

5. The automated laboratory apparatus according to claim 1, further including an insert disposed between the support and the clamping member, for adjusting a height of the pressure chamber assembly relative to the cam assembly.

6. The automated laboratory apparatus according to claim 1, further including a pressure sensor for monitoring pressure in the pressure chamber.

7. The automated laboratory apparatus according to claim 1, further including a source of compressed air in fluid communication with the pressure chamber via a supply line, and at least one valve connected to the supply line for charging and discharging the pressure chamber.

8. The automated laboratory apparatus according to claim 1, further including a controller electrically connected to one or more of the actuator, the pressure sensor, and the at least one valve.

9. The automated laboratory apparatus according to claim 1, further including a user interface electrically connected to the controller for setting test parameters and monitoring pressure in the pressure chamber.

10. The automated laboratory apparatus according to claim 1, further including a plurality of test units.

11. A method of testing durability of a tire coated with a self-sealing sealant for leak-proof performance, the method comprising the steps of:
providing the automated laboratory apparatus according to claim 1;
providing the substrate, wherein the substrate is a tire sample cut from a tire, the tire sample including a tire tread on one surface, the tire sample further including an opposite inner surface having a layer of self-sealing sealant thereon;
sandwiching the tire sample between the pressure chamber main body and the clamping member with the tire tread of the tire sample facing the clamping member and the layer of sealant on the inner surface of the tire sample facing the pressure chamber;
inserting the driven member into the tire sample through the central opening in the clamping member, the driven member being a puncturing object;
mounting the pressure chamber assembly onto the support and the inserted driven member onto the cam assembly;
charging the pressure chamber with compressed air to a predetermined set pressure;
actuating the actuator to drive the puncturing object and cause the puncturing object to move within the tire sample in one or both of an oscillating linear and an oscillating rocking motion;
monitoring the pressure in the pressure chamber while the puncturing object is driven;
dismounting the puncturing object from the cam assembly and dismounting the pressure chamber assembly to check for leaks at a puncture site in the tire sample;
removing the puncturing object from the tire sample and mounting another driven member onto the cam assembly, the driven member being a blunt object;
mounting the pressure chamber assembly onto the support, whereby the blunt object contacts the tire tread of the tire sample;
actuating the actuator to drive the blunt object and cause the blunt object to move so that it periodically punches the tire tread of the tire sample proximate to the puncture site;
monitoring the pressure in the pressure chamber while the blunt object is driven; and
subsequently subjecting the automated laboratory apparatus including the tire sample to a thermal cycle while further monitoring the pressure in the pressure chamber and checking for leaks at the puncture site.

12. The method according to claim 11, further including the step of monitoring the inner surface of the tire sample in the pressure chamber via the monitoring window.

13. The method according to claim 11, further including the step of using a camera to monitor and/or record activity in the pressure chamber at the puncture site.

14. The method according to claim 11, further including the step of providing an environmental chamber within which the automated laboratory apparatus is placed, wherein one or both of the temperature and humidity in the environmental chamber is adjusted while the automated laboratory apparatus is in the environmental chamber.

15. The method according to claim 11, further including the step of preforming the steps of actuating the actuator and monitoring the pressure at one or both of a plurality of ambient temperatures and a plurality of humidity levels.
